(19) United States
(12) Patent Application Publication
(10) Pub. No.: US 2002/0133432 A1
(43) Pub. Date: Sep. 19, 2002

(54) Electronic shopping system

(76) Inventor: Shinji Yamashita, Hyogo (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/987,122

(22) Filed: Nov. 13, 2001

(30) Foreign Application Priority Data
Mar. 16, 2001 (JP) 2001-76870

(51) Int. Cl. G06F 17/60

(52) U.S. Cl. 705/27

(57) ABSTRACT

An electronic shopping system enables a user to purchase one or more commodities by way of a network such as the Internet. The electronic shopping system comprises a private information input unit for inputting private information on the user as well as an image of the user, and an image superimposing unit for processing the image of the user based on the private information input by the private information input unit, for superimposing the processed image of the user upon an image of a commodity specified by the user so as to produce a composite image, and for providing the composite image for the user.

### BACKGROUND OF THE INVENTION

1. Field of the Invention

The present invention relates to an electronic shopping system that, through online shopping by way of a network such as the Internet, provides a user (or purchaser) with services for enabling the user to have a virtual experience of using a commodity selected by superimposing an image of the user upon an image of the commodity so as to produce a composite image and providing the produced composite image for the user.

2. Description of the Prior Art

Conventionally, when a user desires to purchase one or more commodities provided by an online store which exists in a network such as the Internet, the user searches for the one or more commodities which he or she wants to purchase with reference to an electronic catalog including the photographs, prices, product outline explanation, etc. of commodities. Then, the user selects the one or more desired commodities and puts them in a shopping wagon so as to perform a purchase procedure online. In this case, the user has no alternative but to select one or more commodities based on only information on commodities, such as their colors, shapes, performances, etc. A problem with such a prior art electronic shopping system is therefore that the user does not understand whether a commodity which the user purchased through the system is just the thing the user had been looking for until the commodity comes to hand. For example, in the case of commodities such as clothes, those who are wearing commodities within an electronic catalog are fashion models and therefore the user has not alternative but to imagine whether a commodity which the user selects suits the user.

FIG. 8 is a block diagram showing the structure of a prior art electronic shopping system as disclosed in Japanese patent application publication (TOKKAIHEI) No. 9-319792 to solve such a problem. In the figure, reference numeral 1 denotes a network, such as the Internet, in which a lot of pieces of communication terminal equipment, such as computers, are connected to one another by way of a public network or the like, reference numeral 20 denotes a service provider, and reference numeral 3 denotes communication terminal equipment disposed on a user side and connected to the service provider 20 by way of the network 1. A user can operate the communication terminal equipment to browse information on various commodities which an online store of the service provider 2 provides, and to purchase one or more commodities provided by the online store. Furthermore, reference numeral 201 denotes a member image RAM for storing images about users who are members of the online store, such as photographs of their faces, photographs of articles which the members have, and so on, reference numeral 202 denotes a commodity image RAM for storing images about commodities which the online store provides, reference numeral 203 denotes an image superimposing unit for superimposing an image read out of the member image RAM 201 upon an image of a commodity read out of the commodity image RAM 202, and reference numeral 204 denotes a control unit that reads an image from the member image RAM 201, reads an image of a commodity from the commodity image RAM 202, sends them to the image superimposing unit 203 to allow the image superimposing unit 203 to superimpose the image read out of the member image RAM upon the image of the commodity, and then transmits a composite image to the communication terminal equipment 3 on the user side by way of the network 1.

In operation, a user who is a member can provide an image for the service provider 2 in advance by operating the communication terminal equipment 3. The image includes a photograph of the user's face, a photograph of the user's whole body, a photograph of the user's art object, furniture or building, and so on. When the control unit 204 of the service provider 2 receives an image, the control unit stores it in a certain storage location of the member image RAM 201.

For example, when a user desires to purchase clothes which an online store of the service provider 2 provides, the user inputs a member identification number and a commodity number specifying the clothes. The communication terminal equipment 3 transmits the input member identification number and the input commodity number to the service provider 2 by way of the network 1. The control unit 204 of the service provider 2 reads the image of the member's whole body from the member image RAM 201 according to the member identification number and reads the image of the clothes which the member desires to purchase from the commodity image RAM 202 according to the commodity number, and then transmits those images to the image superimposing unit 203. The image superimposing unit 203 simply superimposes the image of the user upon the image of the clothes so as to produce a composite image and transmits the composite image to the control unit 204. The control unit 204 transmits the produced composite image to the communication terminal equipment 3 by way of the network 1, and the communication terminal equipment 3 displays the received composite image on a display such as a liquid crystal display (not shown in the figure). As a result, the user can determine whether the clothes which the user desires to purchase suit the user.

A problem with a prior art electronic shopping system constructed as above is that the user has no alternative but to determine the image of a desired commodity only by watching a composite image in which the user's photograph is simply superimposed upon an image of the commodity, and therefore the user cannot avoid trouble that the commodity which the user has purchased does not suit the image which the user has.

In other words, although a prior art electronic shopping system can offer an environment in which when the user purchases a commodity, such as clothes or an accessory, the user can predict whether the commodity suits the user's own figure to some extent by watching a composite image in which a photograph of the user's face is incorporated into an image of the commodity, the system does not make it possible for the user to have a virtual try-on experience as if the user were actually trying on the commodity because there are differences between the photograph of the user's face and the image of the commodity in scale, shade, and so on.

### SUMMARY OF THE INVENTION

The present invention is proposed to solve the above-mentioned problems, and it is therefore an object of the present invention to provide an electronic shopping system that enables a user to have a virtual experience which is made to appear much closer to reality so that the user can easily and surely determine whether a desired commodity which the user wants to purchase suits the image which the user has.

In accordance with an aspect of the present invention, there is provided an electronic shopping system for enabling a user to purchase one or more commodities by way of a network, the system comprising: a private information input unit for inputting private information on the user as well as an image of the user; and an image superimposing unit for processing the image of the user based on the private information input by the private information input unit, for superimposing the processed image of the user upon an image of a commodity specified by the user so as to produce a composite image, and for providing the composite image for the user. Accordingly, the present invention provides an advantage of being able to offering an environment in which the user can determine whether a desired commodity which the user wants to purchase suits the image which the user has, that is, the user can have a virtual experience of using the commodity which is made to appear much closer to reality.

In accordance with another aspect of the present invention, the input private information is size information on one or more sizes of the user, and the image superimposing unit processes the image of the user image according to the size information and superimposes the processed image of the user upon the image of the commodity specified by the user so as to produce a composite image. Accordingly, the present invention provides an advantage of being able to offering an environment in which the user can have a virtual try-on of a commodity, such as clothes, which is made to appear much closer to reality.

In accordance with a further aspect of the present invention, the image superimposing unit performs image processing on the image of the user so that the image can be displayed in the same colors as those in which the image of the commodity is displayed. Accordingly, the present invention provides an advantage of being able to offering an environment in which the user can easily and surely determine whether a desired commodity which the user wants to purchase suits the image which the user has, that is, the user can have a virtual experience of using the commodity which is made to appear much closer to reality.

In accordance with another aspect of the present invention, the image superimposing unit enlarges or reduces the image of the user so that the image has the same scale as the image of the commodity specified by the user and then superimposes the enlarged or reduced image of the user upon the image of the commodity. Accordingly, the present invention provides advantages of making it possible for the user to confirm sizes of a desired commodity more clearly, and of being able to provide a new additional service to ship the desired commodity after changing one or more sizes of the commodity.

In accordance with a further aspect of the present invention, the composite image produced by the image superimposing unit is a three-dimensional composite image. Accordingly, the present invention provides advantages of making it possible for the user to be able to confirm the appearance of the user who looks as if the user were using the commodity from an arbitrary viewpoint, so that the user can have a virtual experience of using the commodity which is made to appear much closer to reality.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an electronic shopping system according to an embodiment of the present invention;

FIG. 2 is a flow chart showing a processing performed by the electronic shopping system according to the embodiment of the present invention;

FIG. 3 is a diagram showing an example of a private information input screen displayed by communication terminal equipment included in the electronic shopping system according to the embodiment of the present invention;

FIG. 4(a) is a diagram showing an example of a photograph of a user's face input by the user;

FIG. 4(b) is a diagram showing an example of an image of a commodity selected by the user;

FIG. 5 is a diagram showing an example of a two-dimensional composite image generated by the electronic shopping system according to the embodiment of the present invention;

FIG. 6 is a diagram showing an example of a three-dimensional composite image generated by an electronic shopping system according to a variant of the embodiment of the present invention;

FIG. 7 is a diagram showing another example of a three-dimensional composite image generated by the electronic shopping system according to the variant of the embodiment of the present invention; and

FIG. 8 is a block diagram showing the structure of a prior art electronic shopping system.

### DETAILED DESCRIPTION OF THE PREFERRED EMBODIMENT

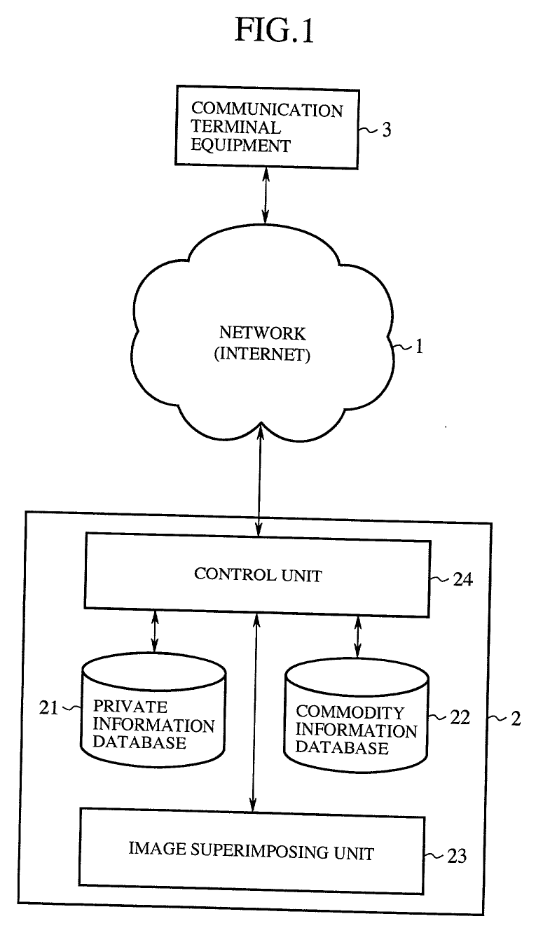

FIG. 1 is a block diagram showing the structure of an electronic shopping system according to an embodiment of the present invention. In the figure, reference numeral 1 denotes a network, such as the Internet, in which a lot of pieces of communication terminal equipment, such as computers, are connected to one another by way of a public network or the like, reference numeral 2 denotes a service provider, and reference numeral 3 denotes communication terminal equipment disposed on a user side and connected to the service provider 2 by way of the network 1. A user can operate the communication terminal equipment 3 to browse information on various commodities which an online store of the service provider 2 provides, and to purchase one or more commodities provided by the online store.

Furthermore, reference numeral 21 denotes a private information database for storing private information on the face and figure-of each user, such as an image of each user (referred to as a user image from here on), such as a photograph of each user's face, each user's height, and information on other sizes of each user, which has been provided in advance by each user or which is provided by each user when he or she accesses the online store, reference numeral 22 denotes a commodity information database for storing an electronic catalog containing information on commodities, such as photographs of the commodities, which the online store provides, reference numeral 23 denotes an image superimposing unit (image superimposing means) for processing a user image, such as a photograph of a user's face, which is read out of the private information database 21, according to information on a size of the user such as the user's height, and for performing image processing on the user image according to the same image processing method by which commodity images are produced so that the user image can be displayed in the same colors as those in which a commodity image upon which the user image is to be superimposed is displayed so as to superimpose the user image upon the commodity image read out of the commodity information database 22, and reference numeral 24 denotes a control unit that reads the user image, such as a photograph of the user's face, from the private information database 21, reads an image of a commodity from the commodity information database 22, sends them to the image superimposing unit 23 to allow the image superimposing unit 23 to superimpose the user image upon the image of the commodity so as to produce a composite image, and transmits the composite image to the communication terminal equipment 3 disposed on the user side by way of the network 1. A private information input means is implemented by the control unit 24 and the communication terminal equipment 3.

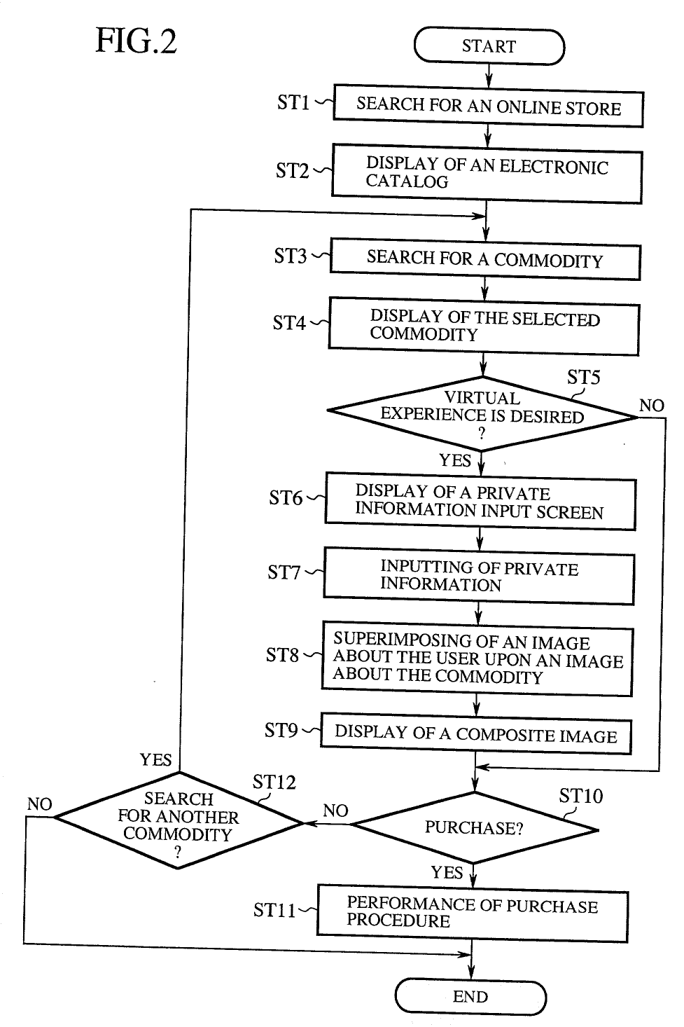

The processing performed by the electronic shopping system according to the embodiment of the present invention in the case where a user purchases clothes through online shopping will be explained as an example with reference to a flow chart of FIG. 2.

When a user, in step ST1, uses an application program, such as a Web browser, on the communication terminal equipment 3 such as a computer, and then searches for and accesses an online store provided by the service provider 2 by way of the network 1 through a search engine or the like, the control unit 24 of the service provider 2, in step ST2, retrieves an electronic catalog containing a list of commodities which the online store provides from the commodity information database 22, and then transmits the electronic catalog to the communication terminal equipment 3 by way of the network 1. The communication terminal equipment 3 displays the received electronic catalog on a display thereof, such as a liquid crystal display (not shown in the figure). When the user further, in step ST3, provides an instruction for searching for a desired commodity by operating the communication terminal equipment 3, the control unit 24 of the service provider 2 searches through the commodity information database 22 according to the searching instruction and transmits commodity information on the desired commodity, such as a photograph of the commodity, the price of the commodity, and a product outline explanation of the commodity, to the communication terminal equipment 3 by way of the network 1. The communication terminal equipment 3, in step ST4, displays the received commodity information on a display thereof, such as a liquid crystal display (not shown in the figure).

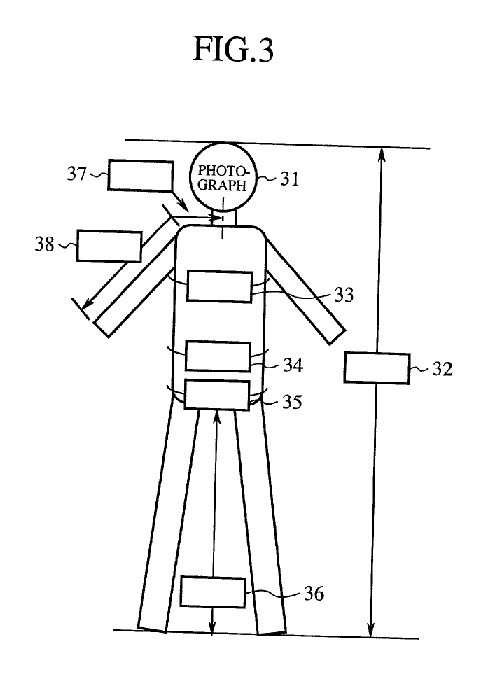

The control unit 24 of the service provider 2 then, in step ST5, inquires of the user whether the user desires a virtual experience (in the case of clothes, a virtual try-on) of the desired commodity which the user searches for through the communication terminal equipment. When the user desires a virtual experience, the control unit 24 of the service provider 2, in step ST6, transmits a private information input screen, as shown in FIG. 3, for enabling the user to input a photograph 31 of the user's face and some pieces of size information 32 to 38 on sizes of the user, which are needed to superimpose the user image upon an image of the commodity (clothes in the case of FIG. 3), to the communication terminal equipment 3 by way of the network 1. When the user inputs some pieces of necessary private information according to the private information input screen, as shown in FIG. 3, which is displayed on the screen of a display of the communication terminal equipment 3, the communication terminal equipment 3, in step ST7, transmits the input private information to the service provider 2 by way of the network 1.

When receiving the private information, the image superimposing unit 23 of the service provider 2, in step ST8, performs processing such as enlargement or reduction of the size of the photograph 31 of the user's face included in the private information according to the size information similarly included in the private information under control of the control unit 24, and performs the same image processing as that performed on the commodity image on the photograph 31 of the user's face so that the photograph can be displayed in the same colors as those in which the commodity image is displayed. For example, when the commodity image is displayed in 256 colors, the image superimposing unit 23 converts the photograph 31 of the user's face in natural colors (the number of colors in which the photograph 31 of the user's face is displayed is limited by the number of colors in which the display of the communication terminal equipment 3 can display the image) to an equivalent image in 256 colors. In addition, the image superimposing unit 23 superimposes the processed photograph 31 of the user's face upon the commodity image under control of the control unit 24 so as to produce a two-dimensional composite image showing the appearance of the user who looks as if the user were trying on the specified commodity (clothes in the case of FIG. 3).

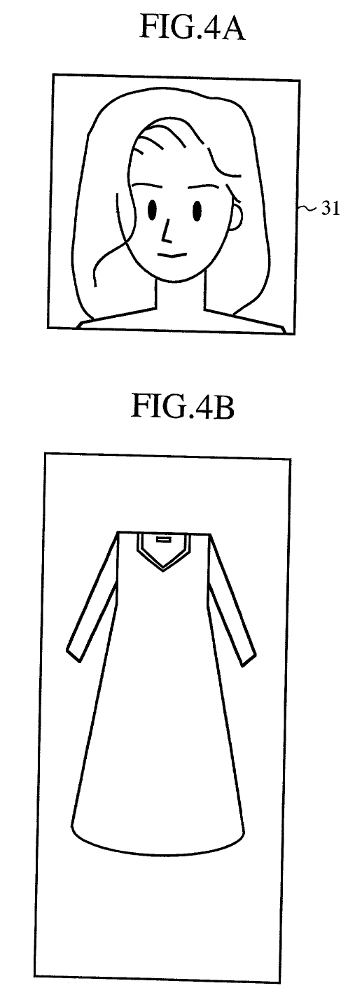

For example, when the user, in step ST7, inputs a photograph 31 of the user's face, as shown in FIG. 4(a), and some pieces of size information 32 to 38, as shown in FIG. 3, such as the user's height, and then, in step ST3, selects a commodity as shown in FIG. 4(b), the image superimposing unit 23 enlarges or reduces the size of the photograph 31 of the user's face as shown in FIG. 4(a) under control of the control unit 24, and performs the same image processing as that performed on the commodity image on the photograph 31 of the user's face so that the photograph can be displayed in the same colors as those in which the commodity image is displayed. The image superimposing unit 23 then superimposes the processed photograph of the user's face upon the commodity image as shown in FIG. 4(b) so as to produce a two-dimensional composite image as shown in FIG. 5. It is not necessary to make a request of the user to input all pieces of size information 32 to 38 as shown in FIG. 3. For example, when the user desires a virtual try-on of clothes such as a pair of trousers, the electronic shopping system can make a request of the user to input only waist 34, hip 35, and groin under 36. The size information is not limited to those pieces of information as shown in FIG. 3.

The control unit 24 of the service provider 2 then, in step ST9, transmits the composite image to the communication terminal equipment 3 by way of the network 1. The user can have a virtual experience as if the user were trying on the desired commodity by seeing the composite image displayed on the screen of a display of the communication terminal equipment 3. As a result, the user surely, in step ST10, determines whether the desired commodity suits the user, and can respond to an inquiry of whether the user performs a purchase procedure to purchase the desired commodity. When receiving a response indicating a request for the performance of the purchase procedure from the communication terminal equipment 3, the service provider 2, in step ST11, transmits an input screen for enabling the user to input various pieces of information, such as a method of payment and the destination of the commodity, so as to urge the user to perform the purchase procedure. In contrast, when the user, in step ST10, does not select the performance of the purchase procedure, the service provider 2, in step ST12, inquires of the user whether to further search for another commodity. When the user does not desire search for any other commodity, the system completes the processing. On the other hand, when the user desires search for another commodity, the electronic shopping system returns to step ST3 and repeats the above-mentioned processing.

As mentioned above, in accordance with the embodiment of the present invention, when a user desires a virtual experience of using a commodity, the electronic shopping system can process a user image, such as a photograph 31 of the user's face, according to size information and performs image processing on the user image so that the user image can be displayed in the same colors as those in which an image of the commodity is displayed. Accordingly, the present embodiment can offer an environment in which the user can easily and surely determine whether a desired commodity which the user wants to purchase suits the image which the user has, that is, the user can have a virtual experience of using the commodity which is made to appear much closer to reality.

Numerous variants may be made in the electronic shopping system according to the above-mentioned embodiment. The image superimposing unit 23 can be so constructed as to perform only processing such as enlargement or reduction of the size of the user image without performing the same image processing as that performed on the commodity image on the user image according to size information so-that the user image can be displayed in the same colors in which the commodity image is displayed. Even in this case, the user can have a virtual experience of using the commodity which is made to appear much closer to reality, though the user may feel a sense of incompatibility in the difference between the user image and the commodity image in shade.

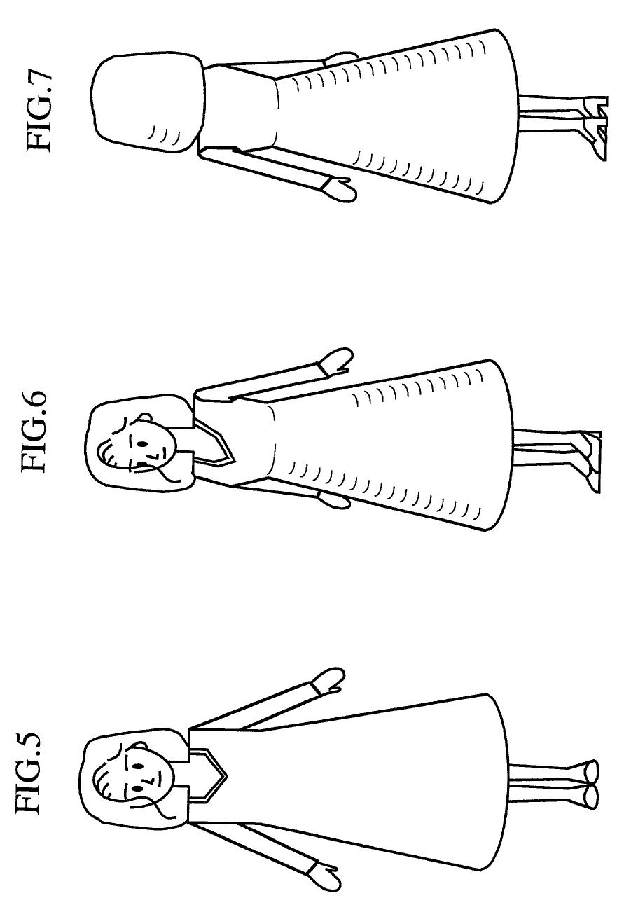

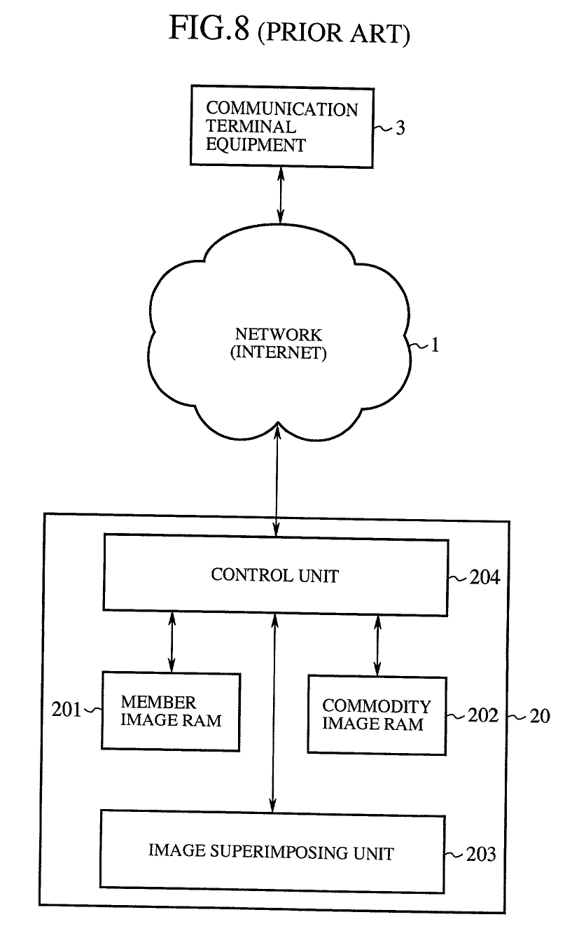

Preferably, the image superimposing unit 23 can superimpose the processed user image, such as a photograph of the user's face, upon the commodity image under control of the control unit 24, so as to produce a three-dimensional composite image showing the appearance of the user who looks as if the user were trying on the specified commodity (clothes in the case of FIG. 3), as shown in FIGS. 6 and 7. In this case, the image superimposing unit 23 can produce a three-dimensional composite image, as shown in FIG. 5, showing that the user is facing forward, first, and the communication terminal equipment 3 displays the three-dimensional composite image. After that, the image superimposing unit 23 can change the viewpoint according to the operation of the user so as to generate and display other three-dimensional composite images as shown in FIGS. 6 and 7.

Display of such a three-dimensional composite image makes it possible for the user to be able to confirm the appearance of the user who looks as if the user were using the commodity from an arbitrary viewpoint, so that the user can have a virtual experience of using the commodity which is made to appear much closer to reality.

Furthermore, the image superimposing processing in step ST8 of FIG. 2 does not necessarily require a process of enlarging or reducing both the user image, such as a photograph of the user's face, and the commodity image so that these images can have the same scale, and processing only has to be performed on those images to such an extent that the user can have a virtual experience of using the commodity. However, processing the user image, such as a photograph of the user's face, and the commodity image so that these images can have the same scale provides another advantage as mentioned below.

For example, when the user has a virtual try-on of clothes as shown in FIGS. 4 to 7, the control unit 24 of the service provider 2, in step ST8 of FIG. 2, can retrieve some pieces of size information on the specified clothes from the commodity information database 22 based on the size information on sizes of the user, as shown in FIG. 3, which is input by the user, and can select the one which seems to be closest to the size information on the user from among those pieces of size information retrieved from the commodity information database 22. Of course, the user can alternatively specify the size of the clothes in advance. The image superimposing unit 23 then performs processing and image processing on the user image, such as a photograph of the user's face, and the commodity image under control of the control unit 24 so that they have the same scale and superimposes the processed user image upon the processed commodity image so as to produce a two-dimensional or three-dimensional composite image showing the appearance of the user who looks as if the user were trying on the specified clothes. As a result, the user can confirm whether the sleeves or the like of the clothes have a length which suits the user's taste by seeing the screen of a display of the communication terminal equipment 3. In addition, the control unit 24 of the service provider 2 can give the user a chance of having a virtual try-on of clothes of another size, and can also transmit an input screen for enabling the user to change one or more sizes of the clothes, such as to change the length of the sleeves of the clothes, or to shorten the clothes, to the communication terminal equipment 3, thereby giving the user a chance of making a request for a change in one or more sizes of the clothes before purchasing the clothes.

Thus, by processing the user image, such as a photograph of the user's face, and the commodity image so that these images can have the same scale to produce a composite image, the user can be made to confirm sizes of a desired commodity more clearly. The system can also provide a new additional service to ship the desired commodity after changing one or more sizes of the commodity.

Many widely different embodiments of the present invention may be constructed without departing from the spirit and scope of the present invention. It should be understood that the present invention is not limited to the specific embodiments described in the specification, except as defined in the appended claims.

What is claimed is:

1. An electronic shopping system for enabling a user to purchase one or more commodities by- way of a network, said system comprising:
a private information input means for inputting private information on the user as well as an image of the user; and
an image superimposing means for processing the image of the user based on the private information input by said private information input means, for superimposing the processed image of the user upon an image of a commodity specified by the user so as to produce a composite image, and for providing the composite image for the user.

2. The electronic shopping system according to claim 1, wherein the input private information is size information on one or more sizes of the user, and said image superimposing means processes the image of the user image according to the size information and superimposes the processed image of the user upon the image of the commodity specified by the user so as to produce a composite image.

3. The electronic shopping system according to claim 1, wherein said image superimposing means performs image processing on the image of the user so that the image can be displayed in the same colors as those in which the image of the commodity is displayed.

4. The electronic shopping system according to claim 2, wherein said image superimposing means performs image processing on the image of the user so that the image can be displayed in the same colors as those in which the image of the commodity is displayed.

5. The electronic shopping system according to claim 2, wherein said image superimposing means enlarges or reduces the image of the user so that the image has the same scale as the image of the commodity specified by the user and then superimposes the enlarged or reduced image of the user upon the image of the commodity.

6. The electronic shopping system according to claim 1, wherein the composite image produced by said image superimposing means is a three-dimensional composite image.
